(19) United States
(12) Patent Application Publication
(10) Pub. No.: US 2018/0220114 A1
(43) Pub. Date: Aug. 2, 2018

(54) SYSTEM FOR CONTROLLING PROJECTOR, INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventor: Akihiro Ouchi, Tokyo (JP)

(21) Appl. No.: 15/881,449

(22) Filed: Jan. 26, 2018

(30) Foreign Application Priority Data
Feb. 1, 2017 (JP) 2017-016792

(51) Int. Cl. H04N 9/31

(52) U.S. Cl. CPC H04N 9/3182

(57) ABSTRACT

A system includes a control unit configured to change a gradation value of an image to be projected by a projection unit according to a gradation value detected from a captured image acquired by capturing a screen on which an image is projected by the projection unit and a generation unit configured to generate an adjustment image for adjusting a projection image shape projected by the projection unit based on the gradation value changed by the control unit.

### BACKGROUND OF THE INVENTION

### Field of Invention

The present invention relates to a projection display system, an information processing apparatus, an information processing method, and a storage medium.

### Description of Related Art

In recent years, more projection display systems using one or a plurality of projection display apparatuses have been installed as a permanent display facility of, for example, an amusement park or a museum. One of issues for a permanently-installed projection display system lies in initial installation of the projection display apparatus and adjustment of a projection image shape for maintaining the image which is displayed at initial installation. In order to manually make the above adjustment, special knowledge and great effort are necessary. Thus, there is a known technique in which an adjustment pattern projected by a projection display apparatus is captured by a camera, and coordinates on the camera image are associated with coordinates managed by the projection display apparatus, where the camera image is necessary for adjusting a projection image shape of the image projected by the projection display apparatus. In a multiple projection technique, a plurality of projectors are arranged in a manner so that projected images from the projectors are overlapped with each other in overlapped areas, so that a single and high-resolution image can be projected on a screen. For correcting the overlapped areas, a reference image having plural characteristic points (e.g. bright spots or crosses arranged at a constant interval) whose coordinate positions are already known is projected on the screen from each of projectors. The positions of the characteristic points on the reference image captured (imaged) by a digital camera are detected. Based on the detected positions of four or more characteristic points of the projectors, the projection images of the projectors are transformed and the overlapped area is detected and a blending process is performed, so that a single and high-resolution image can be projected on the screen.

As a method for associating the coordinates on the camera image with the coordinates managed by the projection display apparatus, the use of a phase shifting method combined with a space coding method is known. In the phase shifting method, a plurality of phase shift patterns, in which a phase of a sinusoidal striped pattern having luminance that changes periodically is shifted by a predetermined amount, is projected on a screen. In the space coding method, a space code pattern as a binary pattern consisting of a bright portion and a dark portion is projected on a screen by a bit count necessary for dividing the space, and the screen on which the space code pattern is projected is captured. An image tone (color gradient) at individual points on the screen changes according to a change in the space code pattern to be projected. Matching a period of the tone of the space code pattern with a period of the phase shift pattern specifies a change in the tone at each point on the screen, thus specifying an order at each point. The order refers to a value that represents a stripe number of the n-th period counted from one end to the other end.

In the space coding method, image tone of the space code pattern is determined at each pixel from a space code image acquired by capturing a measurement target object on which the space code pattern is projected. There has been known a method for accurately determining the image tone by projecting and capturing an inverted code pattern in which a bright portion and a dark portion are inverted in addition to projecting and capturing the space code pattern with the bright portion and the dark portion (Japanese Patent Application Laid-Open No. 2008-145139).

In both of the phase shifting method and the space coding method, it is a prerequisite that the projected image is captured by a camera with an appropriate exposure setting. If exposure of the camera is not set appropriately, a phase cannot be detected appropriately through the phase shifting method, and a period of the tone cannot be detected accurately through the space coding method because of image artifacts, such as “halo” of the brightness. Accordingly, appropriately setting the exposure of the camera has to be performed previously. Furthermore, even if the appropriate setting has been already performed once, the user has to recheck whether the exposure setting of the camera is appropriate and readjust the exposure if necessary when the surrounding environment changes, such as a room lamp having changed from an OFF state to an ON state or from an ON state to an OFF state. This process of adjustment takes time and effort.

### SUMMARY OF THE INVENTION

According to an aspect of the present invention, a system includes a control unit configured to change a gradation value of an image to be projected by a projection unit according to a gradation value detected from a captured image acquired by capturing a screen on which an image is projected by the projection unit, and a generation unit configured to generate an adjustment image for adjusting a projection image shape projected by the projection unit based on the gradation value changed by the control unit.

Further features of the present invention will become apparent from the following description of exemplary embodiments with reference to the attached drawings.

### BRIEF DESCRIPTION OF THE DRAWINGS

FIG. 1 is a block diagram illustrating an example of a system configuration of an image display system according to a first exemplary embodiment.

FIG. 2 is a block diagram illustrating an example of a software configuration of a computer.

FIG. 3 is a flowchart illustrating an example of information processing according to the first exemplary embodiment.

FIG. 4 is a block diagram illustrating an example of a system configuration of an image display system according to a second exemplary embodiment.

FIG. 5 is a flowchart illustrating an example of information processing according to the second exemplary embodiment.

### DESCRIPTION OF THE EMBODIMENTS

Hereinafter, an exemplary embodiment of the present invention will be described with reference to the appended drawings.

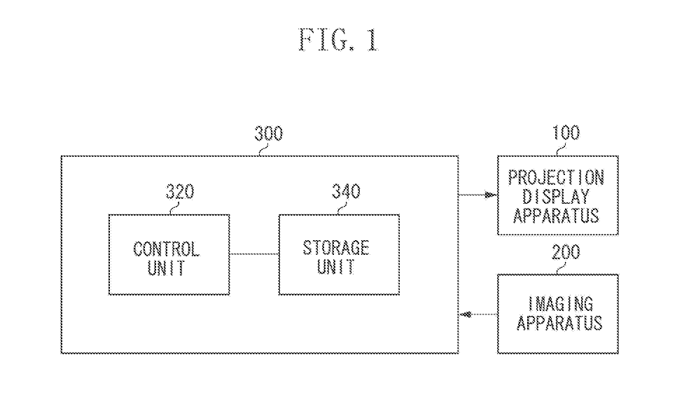

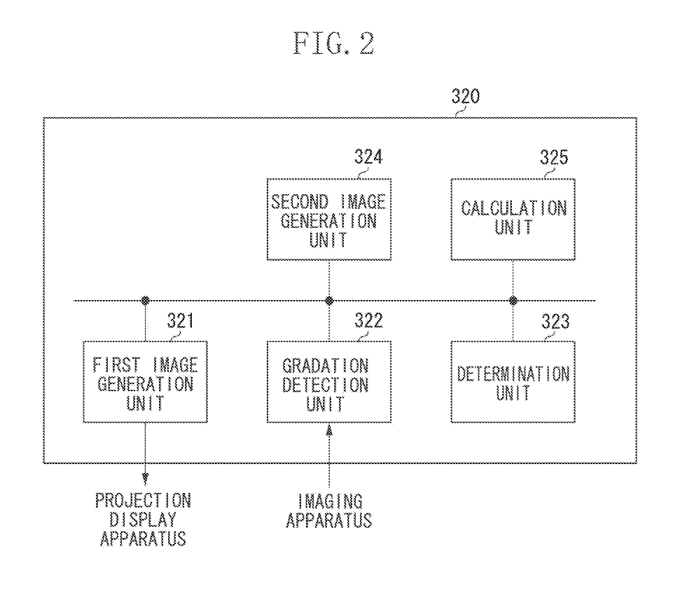

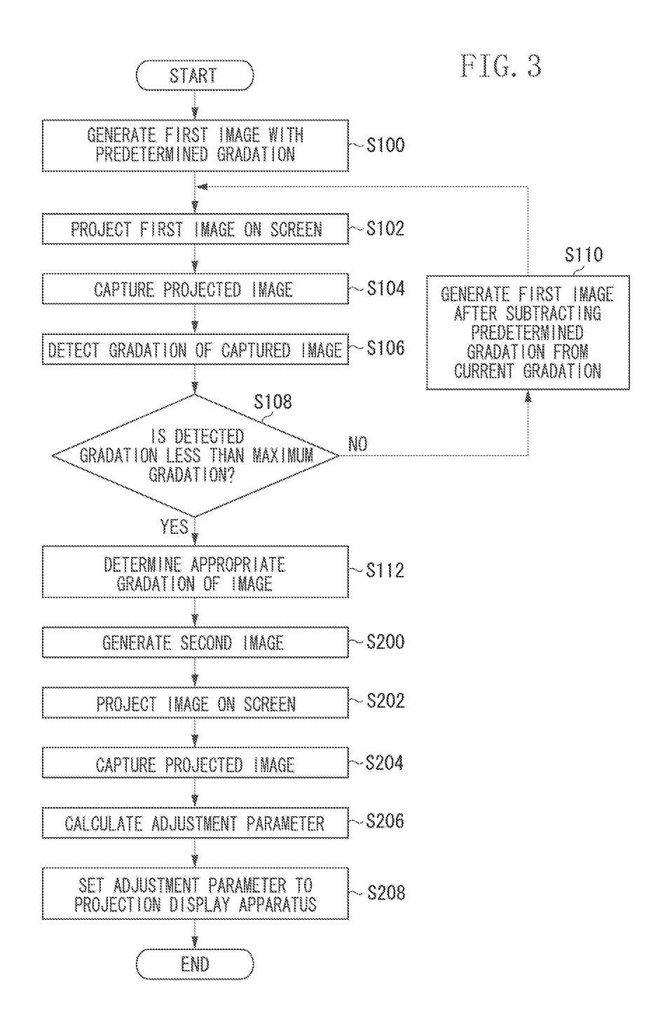

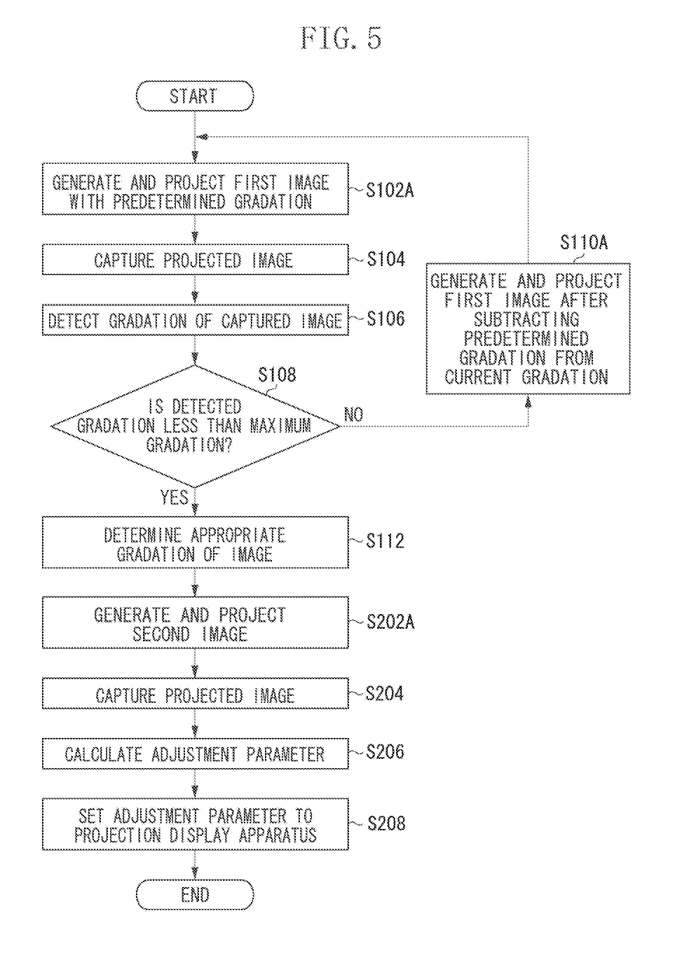

A first exemplary embodiment of the present invention will be described in detail below. FIG. 1 is a block diagram illustrating an example of a system configuration of an image display system according to the present exemplary embodiment. The image display system includes a projection display apparatus 100, an imaging apparatus 200, and a computer 300. The projection display apparatus 100 is a projector for projecting an image used for making an adjustment on a projection display shape generated by the computer 300. The imaging apparatus 200 is, for example, a camera for capturing the image used for adjustment of the projection display shape of the projected image. The computer 300 includes a control unit 320 having a not-shown central processing unit (CPU) and a storage unit 340 having a read only memory (ROM) and a random access memory (RAM). The control unit 320 controls the computer 300, the projection display apparatus 100, and the imaging apparatus 200. The storage unit 340 stores a program to be executed by the CPU for controlling the operation of the control unit 320 and image data captured by the imaging apparatus 200. The CPU in the control unit 320 executes processing based on the program stored in the storage unit 340 to realize a software configuration of the computer 300 illustrated in FIG. 2 and processing illustrated in flowcharts in FIGS. 3 and 5 described below. Each of the projection display apparatus 100 and the imaging apparatus 200 also includes a control unit and a storage unit, and the respective control units execute processing based on a program stored in the corresponding storage unit to realize a function of the corresponding one of the apparatuses 100 and 200.

FIG. 2 is a block diagram illustrating an example of a software configuration of the computer 300. As a software configuration, the computer 300 includes a first image generation unit 321, a gradation detection unit 322, a determination unit 323, a second image generation unit 324, and a calculation unit 325.

The first image generation unit 321 generates an image with which a gradation value of the image projected by the projection display apparatus 100 is detectable, for example, a full-screen solid image having a predetermined gradation value. As used herein, gradation (or image gradient) refers to its ordinary meaning as a directional change in the intensity or color of an image, where each pixel of a gradient image measures the change in intensity in a given direction.

The image generated by the first image generation unit 321 and projected and displayed by the projection display apparatus 100 is captured by the imaging apparatus 200, and the gradation detection unit 322 receives the captured image and detects the gradation value of the projection image in the received captured image. The gradation value of the projection image can be detected with a gradation that takes approximately 50% of the entire imaging area. Here, “50%” is a value based on the premise that the arrangement of the projection display apparatus 100 and the imaging apparatus 200 is determined in such a manner that the imaging area of the projection image takes 50% or more of the entire imaging area of the imaging apparatus 200. The value is however not limited thereto. Here, a gradation value to be detected by the gradation detection unit 322 is within the range of 0 to 255 in a case where the captured image is in 8-bit gradation.

The determination unit 323 determines whether the projected display image captured by the imaging apparatus 200 is captured appropriately. In other words, the determination unit 323 determines whether the gradation value of the projection image is appropriate. For example, in a case where the captured image is in 8-bit gradation and a detected gradation value is 255, the determination unit 323 determines that the captured image has not been captured appropriately. In a case where a detected gradation value is less than 255, the determination unit 323 determines that the captured image has been captured appropriately. For example, in a case where the captured image is in 8-bit gradation and the gradation value detected by the gradation detection unit 322 is 255, the captured image is likely to be saturated. Thus, the determination unit 323 determines that the captured image has not been captured appropriately. On the other hand, in a case where the gradation value detected by the gradation detection unit 322 is less than 255, the captured image is not saturated. In this case, the determination unit 323 determines that the captured image has been captured appropriately.

In addition, a determination method executed by the determination unit 323 is not limited to the above-described method. For example, for an image to be captured in 8-bit gradation, a gradation value ranging from 240 to 250 inclusive is determined in advance as an appropriate gradation for an image to be captured. Then, the determination unit 323 determines that the captured image is appropriate in a case where the gradation value detected by the gradation detection unit 322 is within this range, and determines that the captured image is not appropriate in a case where the gradation value is not within the range. Furthermore, the determination unit 323 may use a value different from 255 for the captured image in 8-bit gradation as a threshold value to be used for determining whether the captured image is appropriate. The threshold value may be a fixed value, or may be changed as appropriate according to a user operation or a projection environment.

In the above-described exemplary embodiment, the determination unit 323 determines that the image is not captured appropriately (i.e., the gradation value of the projection image is not appropriate) in a case where the value of the gradation detected by the gradation detection unit 322 is the maximum value of the captured image. However, the exemplary embodiment is not limited thereto. For example, gradation values of a plurality of pixels detected by the gradation detection unit 322 are arranged in the order from the highest gradation value, and the determination unit 323 may determine that the image is not captured appropriately in a case where the gradation value that is a predetermined-number highest from the highest gradation (e.g., 10-th highest gradation value) is the maximum gradation value of the captured image (e.g., 255). By employing the above-described configuration in a case where, for example, only a small proportion of the pixels of the captured image has the maximum gradation value of the captured image, it is possible to determine that the projected display image is captured appropriately.

The second image generation unit 324 generates an image (second image) having a maximum value of the gradation detected by the gradation detection unit 322 as the maximum gradation value in a case where the determination unit 323 determines that the projected display image is captured appropriately. This image (second image) is used for associating the coordinates on the captured image with the coordinates which the projection display apparatus 100 manages in order to control the position of the projection image. For example, if the phase shifting method is employed, this image includes a sinusoidal pattern having luminance that changes periodically. If the space coding method is employed, this image includes a binary stripe pattern having a bright portion and a dark portion.

The calculation unit 325 associates, by using a captured image of the second image, the coordinates on the captured image with the coordinates that the projection display apparatus 100 manages in order to control a position of the projection image. By associating the coordinates on the captured image with the coordinates that the projection display apparatus 100 manages, in other words, by determining the positional relationship between the coordinates on the captured image and the coordinates that the projection display apparatus 100 manages, a homography matrix can be obtained. Furthermore, a normal line of the flat screen can be estimated from the homography matrix. The estimation of the normal line of the flat screen enables calculation of a parameter to be used for adjusting the projection image shape in such a manner that the projection image shape becomes a rectangle when viewed from the direction of the normal line of the flat screen.

In the present exemplary embodiment, a configuration illustrated in FIG. 2 is described as a software configuration. However, all or a part of the configuration in FIG. 2 may be mounted on the computer 300 as a hardware configuration.

FIG. 3 is a flowchart illustrating an example of information processing for adjusting a projection image shape, according to the present exemplary embodiment. Hereinafter, for the sake of simplicity, it is assumed that the control unit 320 executes processing in the computer 300 by executing programed algorithms (e.g., process of FIG. 3) stored in storage unit 340.

In step S100, the control unit 320 generates, for example, a full-screen solid image having a maximum gradation value as an image from which the gradation value of the image projected by the projection display apparatus 100 is detectable. For the image generated in step S100, it is only required that an approximate gradation of the image is detectable from the image, and the image may partially include an optional pattern. In step S102, the control unit 320 transmits the image (first image) generated in step S100 to the projection display apparatus 100. The projection display apparatus 100 projects the image received from control unit 320 onto a display surface or plane (e.g., a screen).

In step S104, the projection image displayed on the screen is captured by the imaging apparatus 200, and the control unit 320 acquires the captured image. The control unit 320 causes the storage unit 340 to store image data of the acquired captured image.

In step S106, the control unit 320 detects the gradation value of the projection image in the captured image. The control unit 320 detects the gradation value of the projection image with the gradation that takes approximately 50% of the entire imaging area. Here, “50%” is a value based on the premise that the arrangement of the projection display apparatus 100 and the imaging apparatus 200 is determined in such a manner that the imaging area of the projection image takes 50% of the entire imaging area of the imaging apparatus 200. The value is not limited thereto.

In step S108, the control unit 320 determines whether the gradation value of the projection image is appropriate. In other words, on the basis of the gradation value detected from the captured image, the control unit 320 determines whether to change a gradation value of an image to be projected by the projection display apparatus 100. For example, in a case where the gradation value (i.e., maximum value of the luminance level) detected by the gradation value detection unit 322 is a maximum gradation value (i.e., 255 for an 8-bit image) of the captured image, the captured image is likely to be saturated. The control unit 320 determines that a gradation value of a projection image should be changed, accordingly. In a case where the detected gradation value is less than the maximum gradation value, the captured image is not saturated. The control unit 320 determines that a gradation value of a projection image should not be changed, accordingly. Alternatively, a determination method executed in step S108 is not limited to the above-described method. For example, while the determination unit 323 may determine that the gradation value is appropriate in a case where the gradation value detected by the gradation value detection unit 322 is within a preset range, the determination unit 323 may determine that the gradation value is not appropriate in a case where the gradation value is not within the preset range. In addition, the determination unit 323 may use a value different from the maximum gradation value of the captured image as a threshold value to be compared with the gradation detected by the gradation detection unit 322. The threshold value may be a fixed value, or may be changed as appropriate according to a user operation or a projection environment. If the control unit 320 determines that the gradation value of the projection image is not appropriate (NO in step S108), processing proceeds to step S110. If the control unit 320 determines that the gradation value of the projection image is appropriate (YES in step S108), processing proceeds to step S112.

In step S110, the control unit 320 generates an image in which a gradation value of the projection image is changed. For example, the control unit 320 generates an image having a gradation value obtained by subtracting a predetermined gradation value from the current gradation value of the projection image. The image to be generated does not necessarily have to be the same as the current projection image if the gradation value thereof is roughly changed. In other words, in steps S102 to S110, the control unit 320 changes the gradation value of the image to be projected by the projection display apparatus 100 according to the gradation value detected from the captured image of the screen on which the image is projected by the projection display apparatus 100. The control unit 320 repeats the processing in steps S110, S102, S104, S106, and S108 until it is determined that the gradation value of the projection image is appropriate. The control unit 320 eventually determines that the maximum gradation value of the projection image with which the gradation value of the captured image detected in step S106 becomes less than the imageable maximum gradation value is appropriate.

In the above processing, the control unit 320 repeatedly executes the processing in steps S110, S102, S104, S106, and S108 to sequentially lower the gradation value from the maximum gradation value, and determines whether the captured image is appropriate based on whether the gradation value of the projected display image captured in the captured image is the maximum gradation value. However, the method is not limited thereto. For example, in step S100, the control unit 320 may start generation of an image having an optional intermediate gradation value and sequentially increase a gradation value of an image to be generated. Furthermore, as a method for changing the gradation value in step S110, the control unit 320 may subtract or add a gradation value corresponding to one-half of a difference with the immediately preceding gradation value so as to bring, through an asymptotic method, the gradation value close to a boundary value at which whether or not the image is saturated is determined. In such a case, in determining the appropriateness of the captured image in step S108, the control unit 320 cannot simply make a determination based on only a gradation value. The control unit 320 thus makes a determination also based on, for example, a difference with the gradation value before the value is changed. For a projection image in the 8-bit gradation, for example, the gradation value of a first projection image is set to 255. In a case where it is determined that the captured image at this time is not appropriate, the gradation value of the projection image immediately before is set to zero, because the current projection image is the first. Then in step S110, a projection image with a gradation value of 128 is generated and projected, and the projected image is captured. Here, in step S108, if the appropriacy of the captured image is determined based on whether the gradation value of the captured image is less than 255, a result of the determination may be incorrect. In other words, in a case where the gradation value of the captured image is less than 255, the gradation of the projection image may be too low. Thus, even if the gradation value of the captured image is less than 255, it is determined that the captured image is not appropriate. The control unit 320 then generates a projection image having a gradation value of 191, an intermediate gradation value between the current projection image having the gradation value of 128 and the projection image that is immediately before the current projection image and has the gradation value of 255. The control unit then projects the generated projection image, and captures the image thereof. In a case where the gradation value of the captured image at this time is less than 255, the gradation of the captured image may be too low. Thus, the control unit 320 generates a projection image having a gradation value of 223, an intermediate gradation value between the current projection image having the gradation value of 192 and the projection image that is before reduction of the gradation value of the projection image and has the gradation value of 255. the control unit then projects the generated projection image, and captures the image thereof. On the other hand, in a case where the gradation value of the captured image at this time is 255, the projection image may be saturated. Thus, the control unit 320 generates a projection image having a gradation value of 160, an intermediate gradation between the current projection image having the gradation value of 192 and the projection image that is before increase of the gradation value and has the gradation value of 128. The control unit then projects the generated projection image, and captures the image thereof. Repeating of these processes brings the gradation value close to a boundary value at which value whether or not the image gradation is saturated is determined.

In step S112, the control unit 320 determines that a gradation value of the first image is an appropriate gradation value, after the projected display image is determined to be captured appropriately in step S108.

In step S200, the control unit 320 generates a second image for adjusting a projection image shape with the determined maximum gradation value. The second image is, for example, a sinusoidal pattern having luminance that changes periodically if the phase shifting method is used. The second image is a binary stripe pattern including a bright portion and a dark portion if the space coding method is used. The second image is an example of the adjustment image. The processing in step S200 is an example of the processing of generating the adjustment image used for adjusting the projection image shape projected by the projection display apparatus 100 based on the changed gradation value. Here the adjustment of the projection image shape is, for example, to adjust an image, which is projected diagonally to the flat screen and trapezoidally distorted, in such a manner that the image becomes a rectangle when viewed from the front of the screen.

In step S202, the control unit 320 transmits the image generated in step S200 to the projection display apparatus 100. The projection display apparatus 100 projects the input image on the screen.

In step S204, the imaging apparatus 200 captures the projection image, and the control unit 320 acquires the captured image from the imaging apparatus 200. The control unit 320 causes the storage unit 340 to store image data about the acquired captured image.

In step S206, the control unit 320 analyzes the captured image of the second image to specify the image coordinates managed by the projection display apparatus 100, and associates the coordinates on the captured image with the coordinates managed by the projection display apparatus 100. A parameter for adjusting the projection image shape projected by the projection display apparatus 100 can be calculated through a known technique if the coordinates on the captured image can be associated with the coordinates managed by the projection display apparatus 100. Thus, detailed descriptions thereof will be omitted. Here, the parameter calculated by the control unit 320 is, for example, a keystone distortion correction parameter included in the projection display apparatus 100.

In step S208, the control unit 320 sets the adjustment parameter calculated in step S206 to the projection display apparatus 100, and ends the information processing for adjusting on the projection image shape.

The control unit 320 repeatedly executes the processing in steps S110, S102, S104, S106, and S108, thus acquiring an appropriate captured image without saturation.

In a case where, for example, the projection image is saturated in the captured image of the binary stripe pattern obtained through the space coding method, a precise boundary between a bright portion and a dark portion cannot be determined because of “halo” of the captured image. In a case where, for example, the projection image is saturated in the captured image of a sinusoidal pattern obtained through the phase shifting method, an accurate phase cannot be determined because a sinusoidal shape in the captured image cannot be determined.

In other words, even if the exposure setting of the imaging apparatus 200 tends to be in an overexposed state, the coordinates on the captured image can be precisely associated with the coordinates managed by the projection display apparatus 100 with the above-described influence of saturation in the captured image being eliminated.

As described above, according to the present exemplary embodiment, controlling the maximum gradation value of the second image for adjusting the projection image shape enables the acquisition of an appropriate captured image regardless of the exposure setting of the imaging apparatus 200. This achieves accurate adjustment of the projection display shape.

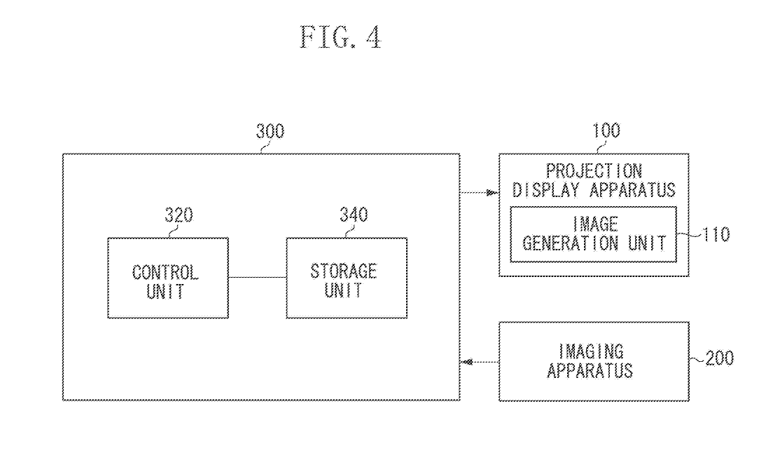

A second exemplary embodiment will be described below in detail. In the image display system according to the first exemplary embodiment, the computer 300 includes the first image generation unit 321 and the second image generation unit 324. The projection display apparatus 100 projects images generated by the first image generation unit 321 and the second image generation unit 324. In the present exemplary embodiment, the projection display apparatus 100 includes an image generation unit 110 as illustrated in FIG. 4.

The image generation unit 110 receives an instruction from the computer 300 and generates images equivalent to the images generated by the first image generation unit 321 and the second image generation unit 324. The image generation unit 110 may read an image stored in a storage unit of the projection display apparatus 100, such as a RAM or a ROM according to an instruction of the computer 300. The image generation unit 110 may be mounted on the projection display apparatus 100 as software or hardware.

FIG. 5 is a flowchart illustrating an example of information processing of adjusting a projection image shape of the present exemplary embodiment.

The processing illustrated in the flowchart of the present exemplary embodiment is different from that of the first exemplary embodiment in steps S102A, S110A, and S202A. In steps S102A, S110A, and S202A, the projection display apparatus 100 generates a full-screen solid image or a shape adjustment image having the corresponding predetermined gradation value in accordance with an instruction of the computer 300 and projects thereof.

As described above, according to the present exemplary embodiment, the projection display apparatus 100 generates an image necessary for adjustment, so that an image signal does not need to be exchanged between the computer 300 and the projection display apparatus 100. This achieves adjustment of the projection display shape with a simple configuration and a short processing time.

In the above-described exemplary embodiment, description has been provided focusing an example of a case where a full-screen solid image (an image having a uniform gradation value over the entire image) is generated by the first image generation unit 321 and projected as the first image. The first image is not limited to the full-screen solid image, and the first image may be an image having a gradation value varying depending on an image region. Alternatively, the user may be allowed to appropriately select whether to use the full-screen solid image or the image having a gradation value varying depending on an image region as the first image.

In the above-described exemplary embodiment, description has been provided focusing on an example case where the projection display apparatus 100, the imaging apparatus 200, and the computer 300 are different apparatuses. The exemplary embodiment is however not limited thereto. For example, a single projector may include all of the functions of the projection display apparatus 100, the imaging apparatus 200, and the computer 300. Furthermore, one projector may include the functions of the projection display apparatus 100 and the computer 300, or may include the functions of the projection display apparatus 100 and the imaging apparatus 200.

Although the exemplary embodiments of the present invention have been described as the above, the present invention is not limited to the specific exemplary embodiments.

Through the processing of the above-described exemplary embodiments, an appropriate captured image can be acquired regardless of the exposure setting of the camera. This enables accurate association of the coordinates on the camera image with the coordinates managed by the projection display apparatus, which is necessary to adjust the projection image shape projected by the projection display apparatus, thus achieving the image display system and the method thereof capable of accurately adjusting the projection display shape.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-016792, filed Feb. 1, 2017, which is hereby incorporated by reference herein in its entirety.

What is claimed is:

1. A system comprising:
a control unit configured to change a gradation value of an image to be projected by a projection unit according to a gradation value detected from a captured image acquired by capturing a screen on which an image is projected by the projection unit; and
a generation unit configured to generate an adjustment image for adjusting a projection image shape projected by the projection unit based on the gradation value changed by the control unit.

2. The system according to claim 1, further comprising:
a determination unit configured to determine whether to change the gradation value of the image to be projected by the projection unit based on the gradation value detected from the captured image,
wherein the control unit changes the gradation value of the image to be projected by the projection unit in a case where the determination unit determines that the gradation value is to be changed, and
wherein the generation unit generates the adjustment image based on the gradation value detected from the captured image in a case where the determination unit determines that the gradation value is not to be changed.

3. The system according to claim 2, wherein the control unit
changes a gradation value of an image,
causes the projection unit to project the image having the changed gradation value on the screen,
causes an imaging unit to capture the image projected on the screen, and
causes the determination unit to determine whether a gradation value of the captured image captured by the imaging unit is a predetermined value.

4. The system according to claim 1, wherein the control unit changes a gradation value of an image by generating an image having a gradation value obtained by subtracting a predetermined gradation value from a current gradation value.

5. The system according to claim 1, wherein the control unit changes a gradation value of an image by, through an asymptotic method, bringing the gradation value close to a boundary value at which value whether or not the image gradation is saturated is determined.

6. The system according to claim 2, wherein the determination unit determines whether a gradation value of a captured image is appropriate based on whether the gradation value of the captured image is less than a maximum gradation value.

7. The system according to claim 1, wherein one information processing apparatus includes the control unit and the generation unit.

8. An information processing apparatus, comprising:
a detection unit configured to detect a gradation value of a captured image acquired by capturing a screen on which an image is projected by a projection unit;
a control unit configured to change a gradation value of a projection image in a case where the gradation value of the captured image detected by the detection unit is not within a predetermined range; and
a generation unit configured to generate an image for adjusting a shape of an image to be projected by the projection unit based on the gradation value within the predetermined range in a case where the gradation value of the captured image detected by the detection unit is within the predetermined range.

9. An information processing method, comprising:
performing control to change a gradation value of an image to be projected by a projection unit according to a gradation value detected from a captured image acquired by capturing a screen on which an image is projected by the projection unit; and
generating an adjustment image for adjusting a projection image shape projected by the projection unit based on the gradation value changed in the control.

10. A non-transitory computer-readable storage medium storing a program for causing a computer to execute an information processing method, comprising:
performing control to change a gradation value of an image to be projected by a projection unit according to a gradation value detected from a captured image acquired by capturing a screen on which an image is projected by the projection unit; and
generating an adjustment image for adjusting a projection image shape projected by the projection unit based on the gradation value changed in the control.
